(19) United States
(12) Patent Application Publication
(10) Pub. No.: US 2023/0382754 A1
(43) Pub. Date: Nov. 30, 2023

(54) Simultaneous CO2 Capture, Mineralization, and Lithium and Other Metal Extraction from Brine

(71) Applicant: University of Houston System, Houston, TX (US)

(72) Inventors: Mohammad RAHIMI, Houston, TX (US); Xiaonan SHAN, Sugar Land, TX (US)

(73) Assignee: University of Houston System, Houston, TX (US)

(21) Appl. No.: 18/199,993

(22) Filed: May 22, 2023

Related U.S. Application Data
(60) Provisional application No. 63/346,187, filed on May 26, 2022.

(51) Int. Cl. C01D 15/08; C25B 1/26; C25B 1/04; C25B 1/16; C01D 3/06; B01J 20/04; B01D 53/02; C25B 15/08

(52) U.S. Cl. CPC C01D 15/08; C25B 1/26; C25B 1/04; C25B 1/16; C01D 3/06; B01J 20/041; B01D 53/02; C25B 15/087; B01D 2257/504; B01D 2253/112

(57) ABSTRACT

A method including capturing carbon dioxide (CO₂) from air (e.g., atmosphere) in an absorber in which the air contacts a base (e.g., a hydroxide, such as potassium hydroxide KOH and/or sodium hydroxide (NaOH)) to produce a carbonate (e.g., potassium carbonate (K₂CO₃) and/or sodium carbonate (Na₂CO₃)); precipitating one or more (e.g., carbonate) salt from an aqueous solution comprising salt (a brine) to provide an aqueous solution comprising a chloride (e.g., potassium chloride (KCl) and/or sodium chloride (NaCl)); using electrochemical regeneration to convert the chloride to electrochemically regenerated product comprising the base (e.g., KOH and/or NaOH); and recycling at least a portion of the electrochemically regenerated product comprising the base to the capturing of the CO₂ from the air. A system for carrying out the method is also provided.

### CROSS REFERENCE TO RELATED APPLICATIONS

This application claims priority to U.S. Patent Application No. 63/346,187 filed May 26, 2022 and entitled “Simultaneous CO₂ Capture and Lithium and Other Metal Extraction from Brine,” the disclosure of which is hereby incorporated herein by reference in its entirety for all purposes not contrary to this disclosure.

### TECHNICAL FIELD

The present disclosure relates to carbon dioxide capture, and more specifically, to direct air carbon dioxide capture in combination with extraction of lithium and/or other metal(s) from aqueous solutions (e.g., brine) comprising the lithium and other metals.

### BACKGROUND

Experts in the lithium-related industry believe that lithium will soon be one of the most important commodities, and therefore, extraction methods need to be updated or replaced to meet the demand. Carbon dioxide (CO₂) capture from air has become of increasing concern. Accordingly, systems and methods for extraction of lithium and CO₂ are being pursued.

### BRIEF DESCRIPTION OF THE DRAWINGS

Embodiments of the present disclosure are described in detail with reference to the drawings. A better understanding of the features and advantages of the disclosed technology will be obtained by reference to the following detailed description that sets forth illustrative embodiments, in which the principles of the technology are utilized, and the accompanying drawings of which:

FIG. 1 is a process flow diagram, according to embodiments of this disclosure;

FIG. 2 is a schematic of a system according to embodiments of this disclosure;

FIG. 3 is a schematic of a system, according to embodiments of this disclosure; and

FIG. 4 is a schematic of potential reactions occurring during the various stages or steps of a method, according to embodiments of this disclosure.

Further details and aspects of various embodiments of the present disclosure are described in more detail below with reference to the appended figures.

### DETAILED DESCRIPTION

Although the present disclosure will be described in terms of specific embodiments, it will be readily apparent to those skilled in this art that various modifications, rearrangements, and substitutions may be made without departing from the spirit of the present disclosure.

For purposes of promoting an understanding of the principles of the present disclosure, reference will be made to exemplary embodiments illustrated in the drawings, and specific language will be used to describe the same. It will nevertheless be understood that no limitation of the scope of the present disclosure is thereby intended. Any alterations and further modifications of the features illustrated herein, and any additional applications of the principles of the present disclosure as illustrated herein, which would occur to one skilled in the relevant art and having possession of this disclosure, are to be considered within the scope of the present disclosure.

The present disclosure relates to carbon dioxide (CO₂) capture and brine lithium (and/or other metal) extraction by an electrochemically-assisted process. The CO₂ capture and brine metal extraction can be performed substantially simultaneously and/or continuously.

The herein disclosed process and system allow for the (e.g., simultaneous) removal/capture of carbon dioxide (CO₂) from the atmosphere (e.g., from air) and extraction of lithium (Li) and/or other metals from an aqueous solution comprising the lithium and/or other metal(s) (referred to herein as a “brine”). The lithium and other metals extracted from the brine can include one or more platinum group metals (e.g., platinum, palladium, iridium, ruthenium, or a combination thereof), one or more rare earth elements (e.g., cerium, dysprosium, erbium, europium, gadolinium, holmium, lanthanum, lutetium, neodymium, praseodymium, rhodium, samarium, scandium, terbium, thulium, ytterbium, yttrium, or a combination thereof).

The brine from which the metal(s) (e.g., lithium, calcium, magnesium, barium, etc.) are extracted could be any salt containing solution, including, but not limited to: produced water from the oil and gas industry, sea water, or salt water from lakes. In embodiments, the system and method of this disclosure also provide hydrogen (H₂), chlorine (Cl₂) and/or fresh water, which can, in embodiments, be essentially pure (e.g., greater than 90, 95, 96, 97, 98, 99, 99.5, 99.9, or 100% pure). The system and method thus allow for: (1) CO₂ capture; (2) extraction of minerals, such as lithium, needed for battery production/regeneration; (3) generation of fresh (e.g., potable) water; (4) hydrogen production; (5) the generation/production of other useful products (e.g., metal salts) and Cl₂; and/or (6) the use of renewable energy to capture the CO₂ from the air and/or to extract the lithium and/or other metal(s).

Experts in the lithium-related industry believe that lithium will soon be one of the most important commodities, and therefore, extraction methods need to be updated or replaced to meet the demand. Unlike traditional lithium mining, direct lithium extraction offers several advantages, including higher recovery efficiency and environmental friendliness. However, direct lithium extraction methods are less mature than the traditional processes. Herein disclosed are a novel process and system for the extraction of lithium (and/or other metal(s)) from brine by an electrochemically-assisted approach, coupled with a carbon capture cycle from the atmosphere. Via the system and method of this disclosure, the extraction of lithium and/or other metal(s) from brine can, in embodiments, not only provide a cleaner, domestic source of lithium for batteries but also significantly assist in climate change mitigation by direct removal of CO₂ from the air, rather than posing an additional carbon footprint throughout the extraction process.

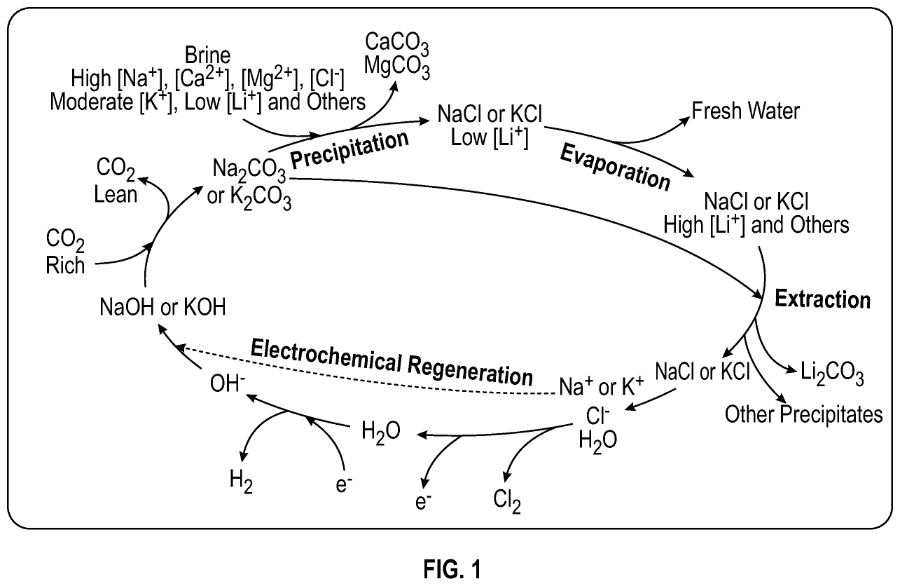

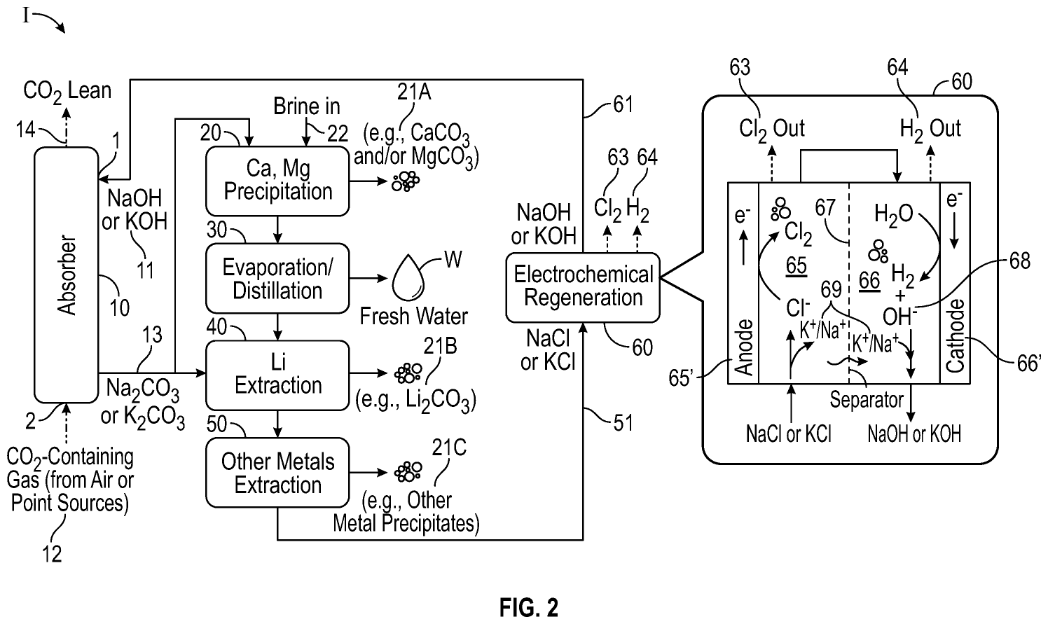

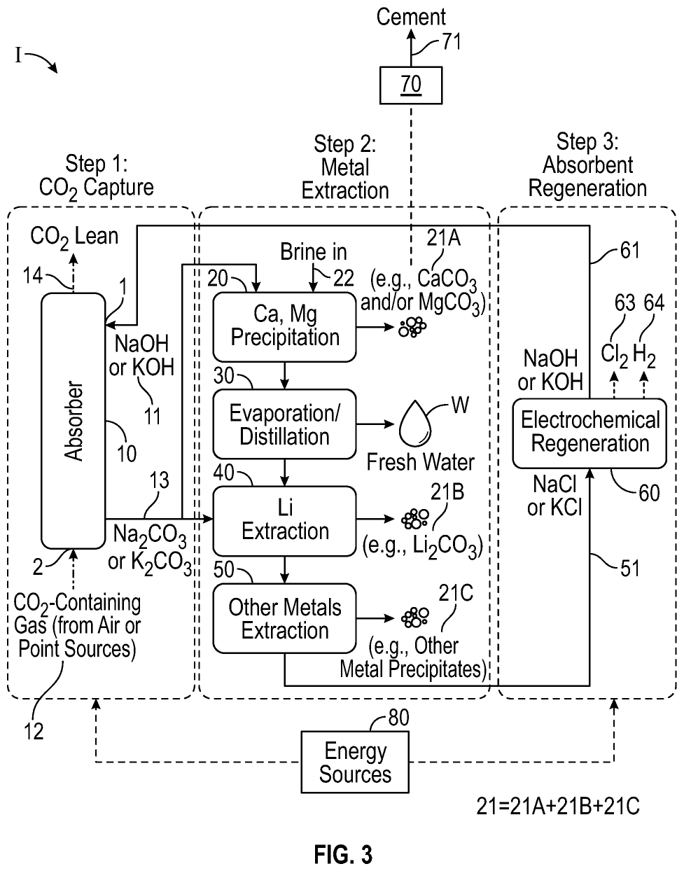

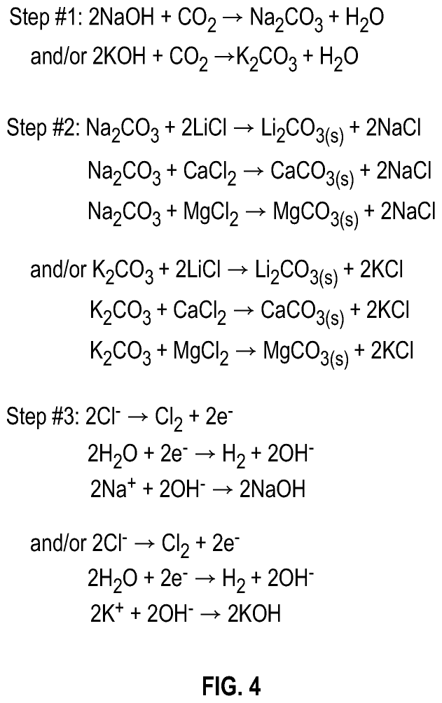

An overview of the herein disclosed system and method will now be made with reference to FIG. 1, which is a schematic process flow diagram, according to embodiments of this disclosure, FIG. 2 and FIG. 3, which are schematic diagrams of a system according to embodiments of this disclosure, and FIG. 4, which is a schematic of potential exemplary reactions occurring during the various stages or steps of a method, according to embodiments of this disclosure.

Although referred to as “steps” or “stages” the various “steps” described hereinbelow can be performed simultaneously, continuously, and in any order, in embodiments. Although, description below refers to extraction of lithium via the herein disclosed system and method, as noted above, other metals can be extracted by the disclosed system and method.

As indicated as Step #1, CO₂ is captured from the air/atmosphere. The capture can be performed at room temperature and pressure, in embodiments. A high concentration of basic (e.g., potassium hydroxide (KOH) and/or sodium hydroxide (NaOH)) solution can flow down through an absorber column, while air flows in from a bottom of the absorber column. The CO₂ in the air can be captured via reaction with the KOH and/or NaOH to produce/generate carbonate (e.g., potassium carbonate (K₂CO₃) and/or sodium carbonate (Na₂CO₃)), for example via the Reaction shown for Step #1 in FIG. 4. Depicted as Step #2, the generated carbonate (e.g., K₂CO₃ and/or Na₂CO₃) can be mixed with a brine solution. The brine solution can comprise produced water produced in the oil industry or from any salt water source that contains lithium and/or other metals (e.g., metals cations), like sea and/or salt lakes. Carbonate (CO₃²⁻) ions can chemically react with the metal ions (e.g., Ca and Mg ions, depicted in FIGS. 2-4) and salts (e.g., carbonate salts, such as, without limitation, CaCO₃ and MgCO₃) can be produced via the reactions depicted at Step #2 in FIG. 4, or like reactions for other cations. The produced salts can be precipitated one by one, or several at a time, depending on the solubility product constant or equilibrium constant, Kₛₚ. Although Ca and Mg are depicted in the FIGS., similar techniques can be utilized to precipitate other metal ions in the brine, for example, until Li ions, which are generally less concentrated in the brine, remain as the dominant ions. Depending on the concentration of the Li ions, a step of solar evaporation, as depicted in FIG. 2, can be utilized to concentrate the Li ion in the remaining brine solution. The carbonate (e.g., K₂CO₃ and/or Na₂CO₃) can be utilized in Step #2 to precipitate the Li ions and form chloride (e.g., KCl and/or NaCl). The carbonate (e.g., K₂CO₃ and/or Na₂CO₃) from Step #1 can be introduced into the various precipitation vessels, as depicted in FIG. 2 and FIG. 3. An evaporation step (solar, or otherwise) can be absent, or employed before and/or after precipitation of one or more salts from the brine. Although referred to as Step #1, Step #2, and Step #3, the steps depicted in the figures and detailed herein can be combined, performed in any order or simultaneously, or can be absent, in embodiments of this disclosure.

Indicated at Step #3, an electrochemical process can be utilized to regenerate the base (e.g., hydroxide, such as KOH and/or NaOH) and can produce H₂ and/or Cl₂. As depicted in FIG. 3, the generated chloride (e.g., KCl and/or NaCl) solution resulting from Step #2 can be introduced into an anode chamber, wherein chloride oxidation reaction can occur and Cl₂ can be generated. A membrane, such as a K⁺ or Na⁺ membrane, can be employed as a separator which allows the K⁺ or Na⁺ ions to diffuse through the membrane. In a cathode chamber, water in the aqueous chloride (e.g., KCl and/or NaCl) solution can be reduced and H₂ and OH⁻ ions can be generated. The ion (e.g., K⁺ and/or Na⁺) that pass through the membrane or are otherwise introduced (e.g., as depicted by the flow line from the top of the cathode chamber into the anode chamber in FIG. 2) will react with OH⁻ and form base (e.g., KOH and/or NaOH) solution. This hydroxide (e.g., KOH and/or NaOH) produced in the electrochemical regeneration Step #3 can then be utilized to capture the CO₂ at Step #1 and thus form a close loop.

It is noted that although KOH/K₂CO₃ and NaOH/Na₂CO₃ are shown in the drawings and described herein, a first compound other than KOH/NaOH can be employed in the CO₂ capture at Step #1, to provide a disparate salt than K2CO₃ or Na₂CO₃ (a second compound) for use in the precipitating at Step #2. In such embodiments, the solution remaining after precipitation at Step #2 and introduced into Step #3 can be disparate from a KCl or NaCl solution (e.g., can be a solution of a third compound). This disparate solution (e.g., the third compound thereof) can be regenerated electrochemically at Step #3 to provide the compound other than KOH or NaOH (the first compound) for recycle to Step #1. Accordingly, a system and method of this disclosure include the CO₂ capture, metal precipitation/extraction, and electrochemical regeneration, but are not intended to be limited to the specific KOH/K₂CO₃/KCl or NaOH/Na₂CO₃/NaCl embodiments depicted in the FIGS. and described in detail herein. Such other first compound/second compound/third compound embodiments will be apparent to those of ordinary skill in the art and with the help of this disclosure.

In embodiments, a method of this disclosure comprises: capturing carbon dioxide (CO₂) from air (e.g., atmosphere) in an absorber in which the air contacts base (e.g., hydroxide, such as potassium hydroxide KOH and/or sodium hydroxide (NaOH)) to produce the related carbonate (e.g., potassium carbonate (K₂CO₃) and/or sodium carbonate (Na₂CO₃)); precipitating one or more (e.g., carbonate) salts from a brine (an aqueous solution comprising salt) to provide an aqueous solution comprising chloride (e.g., potassium chloride (KCl) and/or sodium chloride (NaCl)); using electrochemical regeneration to convert the chloride to electrochemically regenerated product comprising the base (e.g., KOH and/or NaOH); and recycling at least a portion of the electrochemically regenerated product comprising the base (KOH and/or NaOH) to the capturing of the CO₂ from the air.

The one or more salts can comprise a carbonate of lithium or of the other metal(s). For example, the one or more salts can comprise calcium carbonate (CaCO₃), magnesium carbonate (MgCO₃), lithium carbonate (Li₂CO₃), barium carbonate (BaCO₃), another salt of a metal cation, or a combination thereof. In applications, the one or more salts comprise lithium carbonate (Li₂CO₃).

As noted hereinabove, the brine can comprise any water comprising the lithium and/or other metals(s), such as, without limitation, produced water, sea water, brackish water, salt water from another source (e.g., a lake), or a combination thereof.

In embodiments, the method further comprises evaporating fresh (e.g., substantially pure, greater than or equal to about 90, 91, 92, 93, 94, 95, 96, 97, 98, 99, 99.5, 99.6, 99.7, 99.8, 99.9, or 100% pure) water from the brine before or after precipitating one or more salts therefrom.

In embodiments, the method can include precipitating at least one of the one or more salts from the brine prior to the evaporating. The at least one of the one or more salts can comprise calcium carbonate (CaCO₃), magnesium carbonate (MgCO₃), barium carbonate (BaCO₃), or a combination thereof. The method can further comprise precipitating at least one other of the one or more salts after the evaporating. The at least one other of the one or more salts precipitated after the evaporating comprises lithium carbonate (Li₂CO₃). In this manner, lithium can be concentrated in the brine prior to precipitation of Li₂CO₃ therefrom.

Using electrochemical regeneration can produces chlorine (Cl₂), hydrogen (H₂), or both, along with the electrochemically regenerated product comprising base (e.g., KOH and/or NaOH). The Cl₂, the H₂, or both can be substantially pure (e.g., greater than or equal to about 99, 99.5, 99.6, 99.7, 99.8, 99.9, or 100% pure).

In embodiments, the CO₂ can be removed from the atmosphere simultaneously with extraction of lithium (or other metal(s)) from the brine via precipitating of carbonate (e.g., lithium carbonate (Li₂CO₃) or carbonate of the other metal(s)).

The method can further comprise producing a cement from at least one of the one or more salts, and/or selling the one or more salts, for example, to be sold/utilized as cement or another use. The at least one of the one or more salts comprises calcium carbonate (CaCO₃), and the method can further comprise producing Ca(OH₂) and/or CaO from the CaCO₃, for the production of, for example, cement, such as a Portland cement.

In embodiments, a source of energy for the capturing, the using of the electrochemical regeneration, or both comprises renewable energy. The renewable energy can comprise solar, wind, or a combination thereof.

As noted above, the base (e.g., KOH and/or NaOH) contacted with the air in the absorber can be a concentrated base (e.g., concentrated KOH and/or NaOH).

In embodiments, as depicted in FIG. 2-3, the base (e.g., KOH and/or NaOH) contacted with the air in the absorber flows down an absorber column of the absorber, while the air flows in from a bottom of the absorber column, whereby CO₂ in the air reacts with the base (e.g., KOH and/or NaOH) to form the carbonate (e.g., K₂CO₃ and/or Na₂CO₃) via the Equation: 2KOH+CO₂→K₂CO₃+H₂O or 2NaOH+CO₂→Na₂CO₃+H₂O.

Precipitating can comprise mixing the brine with the K₂CO₃, such that carbonate ions (CO₃²⁻) react with cation(s) (e.g., Ca²⁺, Mg²⁺, Ba²⁺, Li⁺) in the brine to precipitate the one or more (e.g., carbonate) salts. By way of examples, precipitating can comprise one or more of the following precipitation reactions, or another precipitation reaction:

K₂CO₃+2LiCl→Li₂CO₃(s)+2KCl;

K₂CO₃+CaCl₂→CaCO₃(s)+2KCl;

K₂CO₃+BaCl₂→BaCO₃(s)+2KCl;

K₂CO₃+MgCl₂→MgCO₃(s)+2KCl;

Na₂CO₃+2LiCl→Li₂CO₃(s)+2NaCl;

Na₂CO₃+CaCl₂→CaCO₃(s)+2NaCl;

Na₂CO₃+BaCl₂→BaCO₃(s)+2NaCl;

Na₂CO₃+MgCl₂→MgCO₃(s)+2NaCl.

During the using electrochemical regeneration, the KCl solution can flow into an anode chamber, whereby chloride oxidation evolution reaction occurs to generate Cl₂. A separator (e.g., a membrane) can be utilized to separate the anode chamber from a cathode chamber. The separator can comprise a membrane, which may or may not be an ion selective membrane. The ion selective membrane can comprise a potassium ion (K⁺) and/or sodium ion (Na⁺) membrane, that allows K⁺ and/or Na⁺, respectively, therethrough. For example, in embodiments, the ion selective membrane comprises a K⁺ membrane that allows K⁺ ions to diffuse therethrough. In embodiments, the ion selective membrane comprises a Na⁺ membrane that allows Na⁺ ions to diffuse therethrough.

In the cathode chamber, water in the chloride (e.g., KCl and/or NaCl) solution can be reduced, thus generating hydrogen (H₂) and hydroxide ions (OH⁻) (e.g., via hydrogen evolution reaction), whereby the OH⁻ ions react with ions (e.g., K⁺ and/or Na⁺ ions) to form the base (e.g., KOH and/or NaOH) of the electrochemically regenerated product that can be recycled to the capturing of the CO₂ from the air to form a closed loop process.

In embodiments, the electrochemical regeneration comprises:

2Cl⁻→Cl₂+2e⁻;

2H₂O+2e⁻→H₂+2OH⁻; and

2K⁺+2OH⁻→2KOH; and/or

2Cl⁻→Cl₂+2e⁻;

2H₂O+2e⁻→H₂+2OH⁻; and

2Na⁺+2OH⁻→2NaOH.

Capturing of the CO₂ from the air can comprise direct air capture and/or can be captured from point sources, such as an industrial factory, a plant, etc. In embodiments, the brine comprises greater than or equal to about 50, 75, or 100 mg/L lithium.

### System

In embodiments, a system I of this disclosure comprises an absorber 10 (e.g., an absorber column) for (e.g., direct) capture of carbon dioxide (CO₂) from air (e.g., atmosphere) via contact of (e.g., concentrated) base 11 (e.g., potassium hydroxide (KOH) and/or sodium hydroxide (NaOH)) with the air or other carbon dioxide-rich fluid 12 to produce carbonate 13 (e.g., potassium carbonate (K₂CO₃) and/or sodium carbonate (Na₂CO₃)); one or more precipitation vessels 20, 40, 50 configured to precipitate one or more salts 21 (e.g., carbonate salts) from a brine 22 via contact of the brine 22 with the carbonate (e.g., K₂CO₃ and/or Na₂CO₃) 13; and an electrochemical regenerator 60 configured to produce an electrochemical regeneration product 61 comprising base (e.g., KOH and/or NaOH) from a chloride (e.g., KCl and/or NaCl) solution 51 remaining after precipitating of the one or more salts 21 from the brine 22. The system can further include a recycle line 61 for recycling at least a portion of the electrochemical regeneration product 61 comprising base (e.g., KOH and/or NaOH) to the absorber 10.

As noted above, in embodiments, the one or more salts 21A, 21B, and/or 21C can comprise calcium carbonate (CaCO₃), magnesium carbonate (MgCO₃), lithium carbonate (Li₂CO₃), barium carbonate (BaCO₃), another metal salt, or a combination thereof. For example, salt 21A extracted in Ca, Mg precipitation vessel 20 can comprise CaCO₃ and/or MgCO₃, salt 21B extracted via Li extraction 40 can comprise Li₂CO₃, and/or salt 21C extracted in other metal extraction 50 can comprise other metal carbonate(s). In embodiments, the one or more salts 21 (e.g., first salt(s) 21A, second salt(s) 21B, and/or third salt(s) 21C) can comprise lithium carbonate (LiCO₃).

As noted hereinabove, the brine 22 can comprise any aqueous solution comprising the lithium and/or the other metals, such as, for example, produced water, sea water, brackish water, salt water from another source (e.g., a lake), or a combination thereof.

The system I of this disclosure can further include an evaporator/distillation column 30 configured for evaporating fresh (e.g., substantially pure, greater than or equal to about 91, 92, 93, 94, 95, 96, 97, 98, 99, 99.5, 99.6, 99.7, 99.8, 99.9, or 100% pure) water 21B from the brine 22 before or after precipitating one or more salts (e.g., salt 21A, 21B, and/or 21C) therefrom.

The evaporator 30 can be downstream from one or more or the precipitation vessels 20, 40, 50 (e.g., downstream a magnesium carbonate (MgCO₃) precipitation vessel(s) 21A, a calcium carbonate (CaCO₃) precipitation vessel 21A, or both), and/or upstream of one or more of the precipitation vessels (e.g., upstream from a lithium carbonate (Li₂CO₃) precipitation vessel 21C). Accordingly, the evaporator 30 can be utilized to remove water W from the brine 22 to concentrate metals (e.g., lithium) therein.

As noted hereinabove, the electrochemical regenerator 60 can produce valuable by-products, such as, chlorine (Cl₂) 63, hydrogen (H₂) 64, or both, along with the electrochemically regenerated product 61 comprising base (e.g., hydroxide, such as KOH and/or NaOH). In embodiments, the Cl₂ 63, the H₂ 64, or both can be substantially pure (e.g., greater than or equal to about 99, 99.5, 99.6, 99.7, 99.8, 99.9, or 100% pure).

In embodiments, the system I is operable to remove the CO₂ from the atmosphere simultaneously with extraction of lithium from the brine via precipitating of lithium carbonate (Li₂CO₃) 21B.

The system I can further comprise cement production apparatus 70 configured for producing a cement 71 from at least one of the one or more salts, for example, from calcium carbonate (CaCO₃) 21A. In embodiments, the cement 71 can comprise a Portland cement.

The system I can further comprise a source of energy 80 for the capturing, the using of the electrochemical regeneration, or both, wherein the source of energy comprises a renewable energy source. The renewable energy source 80 can comprise, for example, sunshine, wind, or a combination thereof.

In embodiments, the absorber 10 has an inlet 1 at a top thereof via which inlet 1 the base 11 (e.g., KOH and/or NaOH) flows down into the absorber column 10, and an inlet 2 at a bottom thereof via which the air or other CO₂-rich gas 12 flows into the absorber column 10, whereby CO₂ in the air or other CO₂-rich gas 12 reacts with the base 11 (e.g., KOH and/or NaOH) to form the carbonate 13 (e.g., K₂CO₃ and/or Na₂CO₃)) via the Equation(s):

2KOH+CO₂→K₂CO₃+H₂O and/or 2NaOH+CO₂→Na₂CO₃+H₂O.

The one or more precipitation vessels 20, 40, 50 can be configured for mixing the brine 22 with the carbonate 13 (e.g., K₂CO₃ and/or Na₂CO₃)), such that carbonate ions (CO₃²⁻) react with cation(s) (e.g., Ca²⁺, Mg²⁺, Ba²⁺, Li⁺) in the brine 22 to precipitate the one or more (e.g., carbonate) salts 21. The one or more precipitation vessels 20, 40, 50 can include one or more precipitations vessels configured to carry out one or more of the following precipitation reactions, and/or another precipitation reaction:

K₂CO₃+2LiCl→Li₂CO₃(s)+2KCl;

K₂CO₃+CaCl₂→CaCO₃(s)+2KCl;

K₂CO₃+BaCl₂→BaCO₃(s)+2KCl;

K₂CO₃+MgCl₂→MgCO₃(s)+2KCl;

Na₂CO₃+2LiCl→Li₂CO₃(s)+2NaCl;

Na₂CO₃+CaCl₂→CaCO₃(s)+2NaCl;

Na₂CO₃+BaCl₂→BaCO₃(s)+2NaCl;

Na₂CO₃+MgCl₂→MgCO₃(s)+2NaCl.

The electrochemical regenerator can comprise an anode chamber 65, into which the chloride (e.g., KCl and/or NaCl) solution 51 flows, whereby chloride oxidation evolution reaction occurs to generate Cl₂.

The electrochemical regenerator can further comprise a separator 67 (e.g., a membrane) that separates the anode chamber 65 (e.g., with associate anode 65′) from a cathode chamber 66 (e.g., with associated cathode 66′). In embodiments, the separator 67 comprises a membrane. In embodiments, the membrane comprises an ion selective membrane. In embodiments, the membrane is not an ion selective membrane. By way of example, the ion selective membrane can comprise a potassium ion (K⁺) and/or sodium ion (Na⁺) membrane. In embodiments, the ion selective membrane comprises a K⁺ membrane that allows K⁺ ions to diffuse therethrough. In embodiments, the ion selective membrane comprises a Na⁺ membrane that allows Na⁺ ions to diffuse therethrough.

In embodiments, the cathode chamber 66 is configured for reduction of water in the chloride 51 (e.g., KCl and/or NaCl) solution, to generate hydrogen (H₂) 64 and hydroxide ions (OH⁻) 68 (e.g., via hydrogen evolution reaction), whereby the OH⁻ ions 68 react with ions 69 (e.g., K⁺ and/or Na⁺ ions) to form the base 61 (e.g., KOH and/or NaOH) of the electrochemically regenerated product that can be recycled to the absorber 10 to form a closed loop. The electrochemical regenerator 60 can be configured, in embodiments, for:

2Cl—→Cl₂+2e⁻;

2H₂O+2e⁻→H₂+2OH⁻; and

2K⁺+2OH⁻→2KOH and/or

2Na⁺+2OH⁻→2NaOH.

In embodiments, the absorber 10 is configured for capturing of the CO₂ from the air via direct air capture. A CO₂-lean stream 14 can exit a top of the absorber 10.

In embodiments, the brine 22 comprises greater than or equal to about 50, 75, or 100 mg/L lithium and/or the other metal(s).

Also provided herein is a system I for (e.g., simultaneously) capturing carbon dioxide (CO₂) from air (e.g., atmosphere) and extracting lithium and/or other metal(s) from a brine 22 via: CO₂ capture via contact of the air or other CO₂-rich gas 12 with a first compound 11 (e.g., KOH and/or NaOH) to provide a second compound 13 (e.g., K₂CO₃ and/or Na₂CO₃), metal extraction/precipitation of one or more salts 21 (e.g., 21A, 21B, 21C) from the brine 22 to provide a remaining brine solution 51 comprising a third compound, and electrochemical (e.g., KOH and/or NaOH) regeneration of the third compound 51 to regenerate/produce a solution 61 of the first compound 11 for recycle to the CO₂ capture, as described herein. In embodiments, the first compound 11 can comprise KOH and/or NaOH, the second compound 13 can comprise K₂CO₃ and/or Na₂CO₃, and the third compound 51 can comprise KCl and/or NaCl.

An advantage of the herein disclosed system and method can be the ability to simultaneously remove CO₂ from the atmosphere (e.g., via direct air capture), and extract lithium and/or other metal(s) from brine. Via this disclosure, a majority of the captured CO₂ can be permanently stored, for example, as calcium and magnesium minerals/salts. These minerals, which are sustainably produced via the herein disclosed system and method, also can be further used, in embodiments, in various industries such as cementing. Since the herein disclosed electrochemically-assisted approach can rely substantially solely on electricity for a power source, renewable energy (such as, without limitation, wind and solar) can be implemented as the source of energy for the system and method. The herein disclosed system and method can also, in embodiments, produce other value-added chemicals from the brine, including theoretically and/or substantially pure streams of chlorine, hydrogen gases, and other salts. Overall, the negative-emission technology provided herein can utilize renewables to produce one or more value-added chemicals from brine and atmospheric CO₂.

In embodiments, the only inputs utilized by the herein disclosed system and method are brine, air, and renewable energy (e.g., solar, wind). The system can include a number of useful products, as described herein, via a water based electrochemically-assisted process.

### EXAMPLES

A product estimation was performed on an embodiment of the system and method described hereinabove. Assuming a brine comprises a produced water (PW) containing 100 mg/L Li⁺. Accordingly, 1 ton of PW contains 100 g of Li. 1000 ton per day would provide 100 kg Li per day, which could be utilized to produce 528 kg Li₂CO₃ per day or about 200 tons per year.

If the PW comprises 500 mg/L Li⁺, about 1000 tons per year of Li₂CO₃ may be produced via the herein disclosed system and method. Assuming a Li₂CO₃ price of $70K per ton, $70 million per year could be obtained from the product Li₂CO₃. Additionally, by-products of the system and method could include: the capture of 30,000 ton of CO₂; ton of CaCO₃ per year (depending on the Ca²⁺ ion concentration in the brine; the production of other metal salts, such as, without limitation, MgCO₃, BaCO₃, etc.; 800 ton of H₂, worth perhaps about $4 million; 28,000 ton of Cl₂ valued at about $4.9 million; and the generation of fresh water.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The phrases “in an embodiment,” “in embodiments,” “in various embodiments,” “in some embodiments,” or “in other embodiments” may each refer to one or more of the same or different embodiments in accordance with the present disclosure. The phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

### ADDITIONAL DISCLOSURE

The following enumerated aspects of the present disclosure are provided as non-limiting examples.

In a first embodiment, a method comprises: capturing carbon dioxide (CO₂) from air (e.g., atmosphere) and/or a CO₂-containing gas (e.g., a CO₂-rich gas) in an absorber in which the air and/or the CO₂-containing gas contacts a base (e.g., a hydroxide, such as potassium hydroxide KOH and/or sodium chloride (NaOH)) to produce a carbonate (e.g., potassium carbonate (K₂CO₃) and/or sodium carbonate (Na₂CO₃)); precipitating one or more (e.g., carbonate) salts from a brine (e.g., an aqueous solution comprising salt) to provide an aqueous solution comprising a chloride (e.g., potassium chloride (KCl) and/or sodium chloride (NaCl)); using electrochemical regeneration to convert the chloride (e.g., KCl and/or NaCl) to electrochemically regenerated product comprising the base (e.g., KOH and/or NaOH); and recycling at least a portion of the electrochemically regenerated product comprising base (e.g., KOH and/or NaOH) to the capturing of the CO₂ from the air and/or the CO₂-containing gas.

A second embodiment can include the method of the first embodiment, wherein the one or more salts comprise calcium carbonate (CaCO₃), magnesium carbonate (MgCO₃), lithium carbonate (Li₂CO₃), barium carbonate (BaCO₃), or a combination thereof.

A third embodiment can include the method of the first or the second embodiment, wherein the one or more salts comprise lithium carbonate (Li₂CO₃).

A fourth embodiment can include the method of any one of the first to third embodiments, wherein the brine comprises produced water, sea water, brackish water, salt water from another source (e.g., a lake), or a combination thereof.

A fifth embodiment can include the method of any one of the first to fourth embodiments, further comprising evaporating fresh (e.g., substantially pure, greater than or equal to about 90, 91, 92, 93, 94, 95, 96, 97, 98, 99, 99.5, 99.6, 99.7, 99.8, 99.9, or 100% pure) water from the brine before or after precipitating one or more salts therefrom.

A sixth embodiment can include the method of the fifth embodiment, comprising precipitating at least one of the one or more salts from the brine prior to the evaporating.

A seventh embodiment can include the method of the sixth embodiment, wherein the at least one of the one or more salts comprises calcium carbonate (CaCO₃), magnesium carbonate (MgCO₃), barium carbonate (BaCO₃), or a combination thereof.

An eighth embodiment can include the method of any one of the sixth or seventh embodiments, further comprising precipitating at least one other of the one or more salts after the evaporating.

A ninth embodiment can include the method of the eighth embodiment, wherein the at least one other of the one or more salts precipitated after the evaporating comprises lithium carbonate (Li₂CO₃).

A tenth embodiment can include the method of any one of the first to ninth embodiments, wherein using electrochemical regeneration produces chlorine (Cl₂), hydrogen (H₂), or both, along with the electrochemically regenerated product comprising the base (e.g., KOH and/or NaOH).

An eleventh embodiment can include the method of the tenth embodiment, wherein the Cl₂, the H₂, or both are substantially pure (e.g., greater than or equal to about 99, 99.5, 99.6, 99.7, 99.8, 99.9, or 100% pure).

A twelfth embodiment can include the method of any one of the first to eleventh embodiments, wherein the CO₂ is removed from the air and/or the CO₂-containing gas (e.g., the CO₂-rich gas) substantially simultaneously with extraction of lithium from the brine via precipitating of lithium carbonate (Li₂CO₃).

A thirteenth embodiment can include the method of any one of the first to twelfth embodiments, further comprising producing a cement from at least one of the one or more salts.

A fourteenth embodiment can include the method of the thirteenth embodiment, wherein the at least one of the one or more salts comprises calcium carbonate (CaCO₃).

A fifteenth embodiment can include the method of the fourteenth embodiment, further comprising producing Ca(OH₂) and/or CaO from the CaCO₃.

A sixteenth embodiment can include the method of the fourteenth or fifteenth embodiment, wherein the cement comprises a Portland cement.

A seventeenth embodiment can include the method of any one of the first to sixteenth embodiments, wherein a source of energy for the capturing, the using of the electrochemical regeneration, or both comprises renewable energy.

An eighteenth embodiment can include the method of the seventeenth embodiment, wherein the renewable energy comprises solar, wind, or a combination thereof.

A nineteenth embodiment can include the method of any one of the first to eighteenth embodiments, wherein the base (e.g., KOH and/or NaOH) contacted with the air in the absorber is a concentrated base (e.g., a concentrated KOH and/or NaOH).

A twentieth embodiment can include the method of any one of the first to nineteenth embodiments, wherein the base (e.g., KOH and/or NaOH) contacted with the air and/or the CO₂-containing gas (e.g., the CO₂-rich gas) in the absorber flows down an absorber column of the absorber, while the air and/or the CO₂-containing gas (e.g., the CO₂-rich gas) flows in from a bottom of the absorber column, whereby CO₂ in the air and/or the CO₂-containing gas (e.g., the CO₂-rich gas) reacts with the base (e.g., the KOH and/or NaOH) to form the carbonate (e.g., the K₂CO₃ and/or Na₂CO₃) via the Equation: 2XOH+CO₂→X₂CO₃+H₂O, wherein X is sodium (Na) and/or potassium (K).

A twenty first embodiment can include the method of the twentieth embodiment, wherein precipitating comprises mixing the brine with the carbonate (e.g., K₂CO₃ and/or Na₂CO₃), such that carbonate ions (CO₃²⁻) react with cation(s) (e.g., Ca²⁺, Mg²⁺, Ba²⁺, Li⁺) in the brine to precipitate the one or more (e.g., carbonate) salts.

A twenty second embodiment can include the method of the twenty first embodiment, wherein the precipitating comprises: K₂CO₃+2LiCl→Li₂CO₃(s)+2KCl; and/or K₂CO₃+CaCl₂→CaCO₃(s)+2KCl; and/or K₂CO₃+BaCl₂→BaCO₃(s)+2KCl; and/or K₂CO₃+MgCl₂→MgCO₃(s)+2KCl; and/or Na₂CO₃+2LiCl→Li₂CO₃(s)+2NaCl; and/or Na₂CO₃+CaCl₂→CaCO₃(s)+2NaCl; and/or Na₂CO₃+BaCl₂→BaCO₃(s)+2NaCl; and/or Na₂CO₃+MgCl₂→MgCO₃(s)+2NaCl.

A twenty third embodiment can include the method of any one of the first to twenty second embodiments, wherein, during the using electrochemical regeneration, the chloride (e.g., KCl and/or NaCl) solution flows into an anode chamber, whereby chloride oxidation evolution reaction occurs to generate Cl₂.

A twenty fourth embodiment can include the method of the twenty third or twenty fourth embodiment, wherein a separator (e.g., a membrane) separates the anode chamber from a cathode chamber.

A twenty fifth embodiment can include the method of the twenty fourth embodiment, wherein the separator comprises a membrane.

A twenty sixth embodiment can include the method of the twenty fifth embodiment, wherein the membrane comprises an ion selective membrane.

A twenty seventh embodiment can include the method of the twenty sixth embodiment, wherein the ion selective membrane comprises a potassium ion (K⁺) and/or sodium ion (Na⁺) membrane, that allows K⁺ and/or Na⁺, respectively, therethrough.

A twenty eighth embodiment can include the method of the twenty seventh embodiment, wherein the ion selective membrane comprises a K⁺ membrane that allows K⁺ ions to diffuse therethrough, or wherein the ion selective membrane comprises a Na⁺ membrane that allows Na⁺ ions to diffuse therethrough.

A twenty ninth embodiment can include the method of any one of the twenty fourth to twenty eighth embodiments, wherein, in the cathode chamber, water in the chloride (e.g., KCl and/or NaCl) solution is reduced, thus generating hydrogen (H₂) and hydroxide ions (OH⁻) (e.g., via hydrogen evolution reaction), whereby the OH⁻ ions react with ions (e.g., K⁺ and/or Na⁺ ions) to form the base (e.g., KOH and/or NaOH) of the electrochemically regenerated product that can be recycled to the capturing of the CO₂ from the air and/or the CO₂-containing gas (e.g., the CO₂-rich gas) to form a closed loop process.

A thirtieth embodiment can include the method of the twenty ninth embodiment, wherein the electrochemical regeneration comprises: 2Cl⁻→Cl₂+2e⁻; 2H₂O+2e⁻→H₂+2OH⁻; and 2K⁺+2OH⁻→2KOH and/or 2Na⁺+2OH⁻→2NaOH.

A thirty first embodiment can include the method of any one of the first to thirtieth embodiments, wherein the capturing of the CO₂ from the air and/or the CO₂-containing gas (e.g., the CO₂-rich gas) comprises direct air capture.

A thirty second embodiment can include the method of any one of the first to thirty first embodiments, wherein the brine comprises greater than or equal to about 50, 75, or 100 mg/L lithium.

In a thirty third embodiment, a system comprises: an absorber (e.g., an absorber column) for (e.g., direct) capture of carbon dioxide (CO₂) from air (e.g., atmosphere) and/or a CO₂-containing gas (e.g., a CO₂-rich gas) via contact of (e.g., concentrated) base (e.g., a concentrated hydroxide, such as potassium hydroxide (KOH) and/or sodium hydroxide (NaOH)) with the air and/or the CO₂-containing gas (e.g., the CO₂-rich gas) to produce a carbonate (e.g., potassium carbonate (K₂CO₃) and/or sodium carbonate (Na₂CO₃)); one or more precipitation vessels configured to precipitate one or more salts (e.g., carbonate salts) from a brine via contact of the brine with the carbonate (e.g., the K₂CO₃ and/or sodium carbonate (Na₂CO₃)); and an electrochemical regenerator configured to produce an electrochemical regeneration product comprising base (e.g., KOH and/or NaOH) from a chloride (e.g., KCl and/or NaCl) solution remaining after precipitating of the one or more salts from the brine.

A thirty fourth embodiment can include the system of the thirty third embodiment, further comprising a recycle line for recycling at least a portion of the electrochemical regeneration product comprising base (e.g., KOH and/or NaOH) to the absorber.

A thirty fifth embodiment can include the system of the thirty third or thirty fourth embodiment, wherein the one or more salts comprise calcium carbonate (CaCO₃), magnesium carbonate (MgCO₃), lithium carbonate (Li₂CO₃), barium carbonate (BaCO₃), or a combination thereof.

A thirty sixth embodiment can include the system of any one of the thirty third to thirty fifth embodiments, wherein the one or more salts comprise lithium carbonate (LiCO₃).

A thirty seventh embodiment can include the method of any one of the thirty third to third sixth embodiments, wherein the brine comprises produced water, sea water, brackish water, salt water from another source (e.g., a lake), or a combination thereof.

A thirty eighth embodiment can include the system of any one of the thirty third to thirty seventh embodiments, further comprising an evaporator configured for evaporating fresh (e.g., substantially pure, greater than or equal to about 90, 91, 92, 93, 94, 95, 96, 97, 98, 99, 99.5, 99.6, 99.7, 99.8, 99.9, or 100% pure) water from the brine before or after precipitating one or more salts therefrom.

A thirty ninth embodiment can include the system of any one of the thirty third to thirty eighth embodiments, wherein the evaporator is downstream from one or more or the precipitation vessels (e.g., downstream a magnesium carbonate (MgCO₃) precipitation vessel, a calcium carbonate (CaCO₃) precipitation vessel, or both), and/or upstream of one or more of the precipitation vessels (e.g., upstream from a lithium carbonate (Li₂CO₃) precipitation vessel).

A fortieth embodiment can include the system of any one of the thirty third to thirty ninth embodiments, wherein the electrochemical regenerator produces chlorine (Cl₂), hydrogen (H₂), or both, along with the electrochemically regenerated product comprising base (e.g., KOH and/or NaOH).

A forty first embodiment can include the system of the fortieth embodiment, wherein the Cl₂, the H₂, or both are substantially pure (e.g., greater than or equal to about 99, 99.5, 99.6, 99.7, 99.8, 99.9, or 100% pure).

A forty second embodiment can include the system of any one of the thirty third to forty first embodiments, operable to remove the CO₂ from the atmosphere simultaneously with extraction of lithium from the brine via precipitating of lithium carbonate (Li₂CO₃).

A forty third embodiment can include the system of any one of the thirty third to forty second embodiments, further comprising cement production apparatus configured for producing a cement from at least one of the one or more salts.

A forty fourth embodiment can include the system of any one of the thirty third to forty third embodiments, wherein the at least one of the one or more salts comprises calcium carbonate (CaCO₃).

A forty fifth embodiment can include the system of the forty fourth embodiment, wherein the cement comprises a Portland cement.

A forty sixth embodiment can include the system of any one of the thirty third to forty fifth embodiments, further comprising a source of energy for the capturing, the using of the electrochemical regeneration, or both, wherein the source of energy comprises a renewable energy source.

A forty seventh embodiment can include the system of the forty sixth embodiment, wherein the renewable energy source comprises sunshine, wind, or a combination thereof.

A forty eighth embodiment can include the system of any one of the thirty third to forty seventh embodiments, wherein the absorber has an inlet at a top thereof via which inlet the base (e.g., KOH and/or NaOH) flows down into the absorber column, and an inlet at a bottom thereof via which the air and/or the CO₂-containing gas (e.g., the CO₂-rich gas) flows into the absorber column, whereby CO₂ in the air and/or the CO₂-containing gas (e.g., the CO₂-rich gas) reacts with the base (e.g., KOH and/or NaOH) to form the carbonate via the Equation(s): 2KOH+CO₂→K₂CO₃+H₂O and/or 2NaOH+CO₂→Na₂CO₃+H₂O.

A forty ninth embodiment can include the system of the forty eighth embodiment, wherein the one or more precipitation vessels are configured for mixing the brine with the carbonate, such that carbonate ions (CO₃²⁻) react with cation(s) (e.g., Ca²⁺, Mg²⁺, Ba²⁺, Li²⁺) in the brine to precipitate the one or more (e.g., carbonate) salts.

A fiftieth embodiment can include the system of the forty ninth embodiment, wherein the one or more precipitation vessels include one or more precipitations vessels configured to carry out: K₂CO₃+2LiCl→Li₂CO₃(s)+2KCl; and/or K₂CO₃+CaCl₂→CaCO₃(s)+2KCl; and/or K₂CO₃+BaCl₂→BaCO₃(s)+2KCl; and/or K₂CO₃+MgCl₂→MgCO₃(s)+2KCl; and/or Na₂CO₃+2LiCl→Li₂CO₃(s)+2NaCl; and/or Na₂CO₃+CaCl₂→CaCO₃(s)+2NaCl; and/or Na₂CO₃+BaCl₂→BaCO₃(s)+2NaCl; and/or Na₂CO₃+MgCl₂→MgCO₃(s)+2NaCl.

A fifty first embodiment can include the system of any one of the thirty third to fiftieth embodiments, wherein the electrochemical regenerator comprises an anode chamber, into which the chloride (e.g., KCl and/or NaCl) solution flows, whereby chloride oxidation evolution reaction occurs to generate Cl₂.

A fifty second embodiment can include the system of the fifty first embodiment, further comprising a separator (e.g., a membrane) that separates the anode chamber from a cathode chamber.

A fifty third embodiment can include the system of the fifty second embodiment, wherein the separator comprises a membrane.

A fifty fourth embodiment can include the system of the fifty third embodiment, wherein the membrane comprises an ion selective membrane.

A fifty fifth embodiment can include the system of the fifty fourth embodiment, wherein the ion selective membrane comprises a potassium ion (K⁺) and/or sodium ion (Na⁺) membrane.

A fifty sixth embodiment can include the system of the fifty fifth embodiment, wherein the ion selective membrane comprises a K⁺ membrane that allows K⁺ ions to diffuse therethrough, and/or wherein the ion selective membrane comprises a Na⁺ membrane that allows Na⁺ ions to diffuse therethrough.

A fifty seventh embodiment can include the system of any one of the fifty second to fifty sixth embodiments, wherein the cathode chamber is configured for reduction of water in the chloride (e.g., KCl and/or NaCl) solution, to generate hydrogen (H₂) and hydroxide ions (OH⁻) (e.g., via hydrogen evolution reaction), whereby the OH⁻ ions react with K⁺ and/or Na⁺ ions to form the base (e.g., the KOH and/or NaOH) of the electrochemically regenerated product that can be recycled to the absorber to form a closed loop.

A fifty eighth embodiment can include the system of the fifty seventh embodiment, wherein the electrochemical regenerator is configured for: 2Cl—→Cl₂+2e⁻; 2H₂O+2e⁻→H₂+2OH⁻; and 2K⁺+2OH⁻→2KOH and/or 2Na⁺+2OH⁻→2NaOH.

A fifty ninth embodiment can include the system any one of any one of the thirty third to fifty eighth embodiments, wherein the absorber is configured for capturing of the CO₂ from the air via direct air capture.

A sixtieth embodiment can include the system of any one of the thirty third to fifty ninth embodiments, wherein the brine comprises greater than or equal to about 50, 75, or 100 mg/L lithium.

In a sixty first embodiment, a system for (e.g., simultaneously) capturing carbon dioxide (CO₂) from air (e.g., atmosphere) and/or a CO₂-containing gas (e.g., a CO₂-rich gas) and extracting lithium and/or other metal(s) from a brine comprises: CO₂ capture via contact of the air and/or the CO₂-containing gas (e.g., the CO₂-rich gas) with a first compound (e.g., KOH and/or NaOH) to provide a second compound (e.g., K₂CO₃ and/or Na₂CO₃), metal extraction/precipitation of one or more salts from the brine to provide a remaining brine solution comprising a third compound, and electrochemical (e.g., KOH and/or NaOH) regeneration of the third compound to regenerate/produce a solution of the first compound for recycle to the CO₂ capture, as described herein.

A sixty second embodiment can include the system of the sixty first embodiment, wherein the first compound can comprise KOH and/or NaOH, the second compound can comprise K₂CO₃ and/or Na₂CO₃, and the third compound can comprise KCl and/or NaCl.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
capturing carbon dioxide (CO₂) from air and/or another CO₂-containing gas in an absorber in which the air and/or the another CO₂-containing gas contacts a base to produce a carbonate;
precipitating one or more salts from a brine to provide an aqueous solution comprising a chloride;
using electrochemical regeneration to convert the chloride to electrochemically regenerated product comprising the base; and
recycling at least a portion of the electrochemically regenerated product comprising base to the capturing of the CO₂ from the air and/or the another CO₂-containing gas.

2. The method of claim 1, wherein the one or more salts comprise lithium carbonate (Li₂CO₃).

3. The method of claim 1, wherein using electrochemical regeneration produces chlorine (Cl₂), hydrogen (H₂), or both, along with the electrochemically regenerated product comprising the base.

4. The method of claim 2, wherein the CO₂ is removed from the air and/or the another CO₂-containing gas simultaneously with extraction of lithium from the brine via precipitating of lithium carbonate (Li₂CO₃).

5. The method of claim 1, wherein a source of energy for the capturing, the using of the electrochemical regeneration, or both comprises renewable energy.

6. The method of claim 1, wherein the base contacted with the air and/or the another CO₂-containing gas in the absorber flows down an absorber column of the absorber, while the air and/or the another CO₂-containing gas flows in from a bottom of the absorber column, whereby CO₂ in the air and/or the another CO₂-containing gas reacts with the base to form the carbonate via the equation: 2XOH+CO₂→X₂CO₃+H₂O, wherein X is sodium (Na) and/or potassium (K).

7. The method of claim 6, wherein precipitating comprises mixing the brine with the carbonate, such that carbonate ions (CO₃²⁻) react with cation(s) in the brine to precipitate the one or more salts.

8. The method of claim 7, wherein the precipitating comprises:
K₂CO₃+2LiCl→Li₂CO₃(s)+2KCl; and/or
K₂CO₃+CaCl₂→CaCO₃(s)+2KCl; and/or
K₂CO₃+BaCl₂→BaCO₃(s)+2KCl; and/or
K₂CO₃+MgCl₂→MgCO₃(s)+2KCl; and/or
Na₂CO₃+2LiCl→Li₂CO₃(s)+2NaCl; and/or
Na₂CO₃+CaCl₂→CaCO₃(s)+2NaCl; and/or
Na₂CO₃+BaCl₂→BaCO₃(s)+2NaCl; and/or
Na₂CO₃+MgCl₂→MgCO₃(s)+2NaCl.

9. The method of claim 1, wherein the electrochemical regeneration comprises:
2Cl⁻→Cl₂+2e⁻;
2H₂O+2e⁻→H₂+2OH⁻; and
2K⁺+2OH⁻→2KOH and/or 2Na⁺+2OH⁻→2NaOH.

10. A system comprising:
an absorber for capture of carbon dioxide (CO₂) from air or another CO₂-containing gas via contact of base with the air and/or the another CO₂-containing gas to produce a carbonate;
one or more precipitation vessels configured to precipitate one or more salts from a brine via contact of the brine with the carbonate; and
an electrochemical regenerator configured to produce an electrochemical regeneration product comprising base from a chloride solution remaining after precipitating of the one or more salts from the brine.

11. The system of claim 10 further comprising a recycle line for recycling at least a portion of the electrochemical regeneration product comprising base to the absorber.

12. The system of claim 10, wherein the one or more salts comprise lithium carbonate (LiCO₃).

13. The system of claim 10, wherein the electrochemical regenerator produces chlorine (Cl₂), hydrogen (H₂), or both, along with the electrochemically regenerated product comprising base.

14. The system of claim 10, wherein the one or more precipitation vessels are configured for mixing the brine with the carbonate, such that carbonate ions (CO₃²⁻) react with cation(s) in the brine to precipitate the one or more salts.

15. The system of claim 10, wherein the electrochemical regenerator comprises an anode chamber, into which the chloride solution flows, whereby chloride oxidation evolution reaction occurs to generate Cl₂.

16. The system of claim 15 further comprising a separator that separates the anode chamber from a cathode chamber.

17. The system of claim 16, wherein the cathode chamber is configured for reduction of water in the chloride solution, to generate hydrogen (H₂) and hydroxide ions (OH⁻), whereby the OH⁻ ions react with alkali ions to form the base of the electrochemically regenerated product that can be recycled to the absorber to form a closed loop.

18. The system of claim 17, wherein the electrochemical regenerator is configured for:
2Cl—→Cl₂+2e⁻;
2H₂O+2e⁻→H₂+2OH⁻; and
2K⁺+2OH⁻→2KOH and/or 2Na⁺+2OH⁻→2NaOH.

19. A system for capturing carbon dioxide (CO₂) from air and/or another CO₂-containing gas and extracting lithium and/or other metal(s) from a brine via: CO₂ capture via contact of the air with a first compound to provide a second compound, metal extraction/precipitation of one or more salts from the brine to provide a remaining brine solution comprising a third compound, and electrochemical regeneration of the third compound to regenerate/produce a solution of the first compound for recycle to the CO₂ capture.

20. The system of claim 19, wherein the first compound comprises KOH and/or NaOH, the second compound comprises K₂CO₃ and/or Na₂CO₃, and the third compound comprises KCl and/or NaCl.
